(19) United States
(12) Patent Application Publication
(10) Pub. No.: US 2013/0318504 A1
(43) Pub. Date: Nov. 28, 2013

(54) Execution Breakpoints in an Integrated Development Environment for Debugging Dataflow Progrrams

(71) Applicants: Johan Eker, Lund (SE); Harald Gustafsson, Lund (SE); Carl Von Platen, Malmo (SE)

(72) Inventors: Johan Eker, Lund (SE); Harald Gustafsson, Lund (SE); Carl Von Platen, Malmo (SE)

(21) Appl. No.: 13/481,765

(22) Filed: May 25, 2012

(51) Int. Cl. G06F 9/44

(52) U.S. Cl. 717/128; 717/129

(57) ABSTRACT

A dataflow program defining actors that pass tokens from one to another via connections is processed by causing one or more processors to access and execute instructions of the dataflow program. Execution of the dataflow program generates events (e.g., token production/consumption, actor state after actor action firing). For each generated event, processing evaluates whether there exists a sequence of events that matches a breakpoint condition, and if such a sequence exists then execution of the dataflow program is halted. The breakpoint condition is at least partially based on an extended history of related events, wherein two events are related to one another if they pertain to a same connection or if they pertain to a same actor state, and wherein the extended history comprises at least two related events.

### BACKGROUND

The present invention relates to dataflow programming environments, and more particularly to execution breakpoints for debugging dataflow programs.

Dataflow modeling is emerging as a promising programming paradigm for streaming applications for multicore hardware and parallel platforms in general. This more constrained programming model benefits high-level transformations and facilitates advanced code optimizations and run-time scheduling.

A dataflow program is made up of a number of computational kernels, (called “actors” or “functional units”) and connections that specify the flow of data between the actors. An important property of a dataflow program is that the actors only interact by means of the flow of data over the connections: there is no other interaction. In particular, actors do not share state. The absence of shared state makes a dataflow program relatively easy to parallelize: the actors can execute in parallel, with each actor's execution being constrained only by the requirement that all of its inputs be available.

FIG. 1 illustrates an exemplary graphical representation of a dataflow program 100 having seven actors, identified with respective reference numerals A, B, C, D, E, F, and G. The actors A, B, C, D, E, F, and G carry out their functions by means of their code (i.e., program instructions) being executed within a processing environment 101 that comprises one or more programmable processors 103 that retrieve program instructions and data from one or more non-transitory processor readable storage media (e.g., as represented by memory 105). Connections between the actors are indicated by arrows. The dataflow program 100 illustrates that an actor can have one or more input connections, and can have any number of output connections, including none. For example, actor G lacks any output ports, and is consequently commonly referred to as a “sink”. A sink does not affect the state of the other actors. In practice, sinks typically represent interaction with the environment in which the dataflow program executes. For example, a sink could represent an actuator, an output device, or the like. A sink could also represent a system that has not yet been implemented, in which case the sink mimics the missing subsystem's demand for input.

Feedback loops can be formed as illustrated in this example by actors C, D, E, and F forming a cycle, and also by actor B having a self-loop. It will be observed that feedback limits parallelism, since an actor's firing (i.e., its execution) may have to await the presence of input data derived from one of its earlier firings.

Communication between actors occurs asynchronously by means of the passing of so-called “tokens”, which are messages from one actor to another. These messages can represent any type of information (e.g., numeric, alphabetic, program-defined values, etc.), with the particular type of information in any one case being defined by the dataflow program. As used herein, the term “value” refers to the particular information (as distinguished from the information type or range of possible information instances) represented by a token or instance of an actor state without any limitation regarding whether that value is numeric, alphabetic, or other, and without regard to whether the information is or is not a complex data structure (e.g., a data structure comprising a plurality of members, each having its own associated value).

The dataflow programming model is a natural fit for many traditional Digital Signal Processing (DSP) applications such as, and without limitation, audio and video coding, radio baseband algorithms, cryptography applications, and the like. Dataflow in this manner decouples the program specification from the available level of parallelism in the target hardware since the actual mapping of tasks onto threads, processes and cores is not done in the application code but instead in the compilation and deployment phase.

In a dataflow program, each actor's operation may consist of a number of actions, with each action being instructed to fire as soon as all of its required input tokens become valid (i.e., are available) and, if one or more output tokens are produced from the actor, there is space available in corresponding output port buffers. Whether the firing of the action occurs as soon as it is instructed to do so or whether it must nonetheless wait for one or more other activities within the actor to conclude will depend on resource usage within the actor. Just as the firing of various actors within a dataflow program may be able to fire concurrently or alternatively may require some sort of sequential firing based on their relative data dependence on one another, the firing of various actions within an actor can either be performed concurrently or may alternatively require that some sequentiality be imposed based on whether the actions in question will be reading or writing the same resource; it is a requirement that only one action be able to read from or write to a resource during any action firing.

An input token that, either alone or in conjunction with others, instigates an action's firing is “consumed” as a result (i.e., it is removed from the incoming connection and ceases to be present at the actor's input port). An actor's actions can also be triggered by one or more state conditions, which include state variables combined with action trigger guard conditions and the action scheduler's finite state machine conditions. Guard conditions may be Boolean expressions that test any persistent state variable of the actor or its input token. (A persistent state variable of an actor may be modeled, or in some cases implemented, as the actor producing a token that it feeds back to one of its input ports.) One example (from among many) of a dataflow programming language is the CAL language that was developed at UC Berkeley The CAL language is described in “CAL Language Report: Specification of the CAL actor language”, Johan Eker and Jörn W. Janneck, Technical Memorandum No. UCB/ERL M03/48, University of California, Berkeley, Calif., 94720, USA, Dec. 1, 2003, which is hereby incorporated herein by reference in its entirety. In CAL, operations are represented by actors that may contain actions that read data from input ports (and thereby consume the data) and that produce data that is supplied to output ports. The CAL dataflow language has been selected as the formalism to be used in the new MPEG/RVC standard ISO/IEC 23001-4 or MPEG-B pt. 4. Similar programming models are also useful for implementing various functional components in mobile telecommunications networks.

Typically, the token passing between actors (and therefore also each connection from an actor output port to an actor input port) is modeled (but not necessarily implemented) as a First-In-First-Out (FIFO) buffer, such that an actor's output port that is sourcing a token pushes the token into a FIFO and an actor's input port that is to receive the token pops the token from the FIFO. An important characteristic of a FIFO (and therefore also of a connection between actor output and input ports) is that it preserves the order of the tokens contained therein; the reader of the FIFO receives the token in the same order in which that token was provided to the FIFO. Also, actors are typically able to test for the presence of tokens in a FIFO connected to one of the actor's input ports, and also to ascertain how many tokens are present in a FIFO, all without having to actually pop any tokens (and thereby remove the data from the FIFO).

The interested reader may refer to U.S. Pat. No. 7,761,272 to Janneck et al., which is hereby incorporated herein by reference in its entirety. The referenced document provides an overview of various aspects of dataflow program makeup and functionality.

It will be appreciated from the above discussion that dataflow driven execution is different from the more traditional control flow execution model in which a program's modules (e.g., procedures, subroutines, methods) have a programmer-specified execution order.

Regardless of which execution model is followed, complex programs will almost always require that the programmer have some type of mechanism for finding errors (so-called “bugs”) in the program. Debugging tools are available for this purpose, and are often incorporated into Integrated Development Environments (IDEs), which may also include such things as program source code editors and build automation tools. An important aspect of debugging a program is the ability for the user to specify a set of conditions, called “breakpoints”, under which program execution should halt. Once halted, the user can examine the values of program variables and states to see whether these are what would be expected if the program is functioning properly. If they are not, some debuggers allow the users to “un-execute” steps to find the point in execution at which an error came into existence. Some debuggers also provide the capability of modifying variables and/or states and then executing program components to see whether correct results are produced.

An important key to debugging, then, is the ability to specify (also called “set”) breakpoints. In programs that are created in accordance with a control flow paradigm, this conventionally means identifying a particular program instruction whose execution unconditionally or conditionally triggers the halt. Some control flow execution debugging tools, such as the open source GNU project Debugger (“GDB”), support the specification of conditional breakpoints. The condition can be an arbitrary imperative programming language expression written in the same language as that of the program being debugged, and that is valid in the context of the breakpoint. With a conditional breakpoint, program execution is halted at the breakpoint if the specified condition is satisfied. One example is checking whether a value is equal to a constant (e.g., “this==NULL”). It is also possible to halt program execution after the breakpoint has been hit (i.e., executed) a specified number of times. It is noted that a conditional breakpoint for a control flow description can only halt the program's execution based on current values of variables and for variables that can be reached from the same context of the breakpoint.

Applying the above-described traditional breakpoint technology to a dataflow programming environment is, at best, very tedious, and at worst largely ineffectual. Dataflow programs are typically executed by a runtime environment that schedules the order of execution of actions. This schedule is based on token availability, token values, and state conditions, and is not generally dictated by the order in which program instructions are written by the programmer. Consequently, existing debug support, which is based on the control paradigm (e.g., by setting breakpoints in the control flow description), presents the creator of a dataflow program with serious challenges.

In view of the foregoing, it is desired to have methods and apparatuses that provide better tools for debugging dataflow programs.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with one aspect of the present invention, the foregoing and other objects are achieved in methods and apparatuses that control execution of a dataflow program that defines one or more actors and one or more connections, wherein each connection passes a token from an output port of any one of the actors to an input port of any one of the actors, and wherein each of the actors has an actor state. Such control includes causing one or more processors to access and execute instructions of the dataflow program, wherein execution of the instructions of the dataflow program causes a plurality of events to be generated, wherein each event is a token produced onto a connection, a token consumed from a connection, or an instance of an actor state after an action firing. In response to generation of an event, it is ascertained whether there exists a sequence of events that matches a breakpoint condition, and if a sequence of events that matches the breakpoint condition exists, then execution of the dataflow program is halted. In such embodiments, the breakpoint condition is at least partially a function of an extended history of related events, wherein two events are considered to be related to one another if they pertain to a same connection or if they pertain to a same actor state, and wherein the extended history comprises at least two related events.

In an aspect of some but not necessarily all embodiments, for each generated event, a trace record is added to a set of trace records that represents a sequence of generated events, wherein the added trace record represents the generated event. In such embodiments, ascertaining whether there exists a sequence of events that matches a breakpoint condition comprises processing the set of trace records to ascertain whether there exists in the set of trace records a representation of a sequence of events represented by the set of trace records that matches the breakpoint condition. In some but not necessarily all of these embodiments, adding the trace record to the set of trace records that represents the sequence of events comprises causing the one or more processors to execute trace record creating instructions that have been merged into a set of program instructions that were generated by a dataflow program build tool.

In an aspect of some but not necessarily all embodiments, ascertaining whether there exists a sequence of events that matches a breakpoint condition comprises causing the one or more processors to execute breakpoint ascertaining instructions that have been merged into a set of program instructions that were generated by a dataflow program build tool.

In an aspect of some but not necessarily all embodiments, ascertaining whether there exists a sequence of events that matches a breakpoint condition comprises, concurrent with causing the one or more processors to access and execute instructions of the dataflow program, causing the one or more processors to trap execution of dataflow program instructions that create tokens or consume tokens, and as part of trap processing to add a trace record to the set of trace records.

In an aspect of some but not necessarily all embodiments, at least one of the breakpoint conditions is at least partly a function of a predicate that is satisfied when there exists at least a minimum number of unconsumed tokens that are associated with one of the connections, wherein the minimum number of tokens is greater than 1.

In an aspect of some but not necessarily all embodiments, at least one of the breakpoint conditions is at least partly a function of a predicate that is satisfied based on a comparison of a value of a first token produced onto a connection with a value of a second token produced onto the connection, wherein the second token is older than the first token.

In an aspect of some but not necessarily all embodiments, at least one of the breakpoint conditions is at least partly a function of a predicate that is satisfied based on a comparison between a specified sequence of values and a historical sequence of two or more token values produced onto a connection. In some but not necessarily all of these embodiments, the historical sequence of two or more token values produced onto the connection comprises as many token values as were produced onto the connection since a most recent resumption of dataflow program execution following a halting of the dataflow program.

In an aspect of some but not necessarily all embodiments, causing the one or more processors to access and execute instructions of the dataflow program comprises causing the one or more processors to simulate execution of the dataflow program.

In an aspect of some but not necessarily all embodiments, causing the one or more processors to access and execute instructions of the dataflow program comprises causing the one or more processors to access and execute a set of program instructions that have been generated by a dataflow program build tool. Additionally, ascertaining whether there exists a sequence of events that matches a breakpoint condition comprises causing the one or more processors to execute breakpoint ascertaining instructions that have been generated by a dataflow program build tool.

### BRIEF DESCRIPTION OF THE DRAWINGS

FIG. 1 illustrates an exemplary graphical representation of a dataflow program having seven actors.

FIG. 2a is, in one respect, a flow chart of steps/processes performed by a debugging tool in accordance with some but not necessarily all exemplary embodiments of the invention.

FIG. 2b is, in one respect, a flow chart of steps/processes performed by a debugging tool in accordance with some but not necessarily all exemplary embodiments of the invention.

FIG. 2c is, in one respect, a flow chart of steps/processes performed by a debugging tool in accordance with some but not necessarily all exemplary embodiments of the invention.

FIG. 3 is a block diagram showing an overall exemplary embodiment of a processing environment that includes elements for enabling breakpoint functionality with respect to a dataflow program.

FIG. 4 is a block diagram showing an alternative exemplary embodiment of a processing environment that includes elements for enabling breakpoint functionality with respect to a dataflow program.

FIG. 5 is a block diagram showing another alternative exemplary embodiment of a processing environment that includes elements for enabling breakpoint functionality with respect to a dataflow program.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits, such as Application Specific Integrated Circuits or “ASICs”, and/or one or more programmed processors). Moreover, the invention can additionally be considered to be embodied entirely within any form of computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments as described above may be referred to herein as “logic configured to” perform a described action, or alternatively as “logic that” performs a described action.

In an aspect of embodiments consistent with the invention, a user/programmer (hereinafter simply referred to as “user”) is provided with one or more dataflow debugging tools that enable the debugging of dataflow programs, including the ability to set breakpoints in a way that is meaningful with respect to the dataflow paradigm.

In an aspect of some but not necessarily all embodiments, breakpoint capability is provided in a dataflow program debugging environment, wherein the breakpoint condition is at least partially a function of what is herein referred to as an “extended history” of related events that are generated as a result of dataflow program execution. An event can be, for example, a token produced onto a connection, a token consumed from a connection, or an instance of an actor state after an action firing. As used throughout this disclosure, two events are considered to be related to one another if they pertain to a same connection or if they pertain to a same actor state. Also, as used throughout this disclosure, the term “extended history” is a set of at least two related events. Thus, for example, two or more tokens produced onto a same connection at different times would be considered an extended history of those events. Similarly, two or more actor states pertaining to a same actor and observed at different times (i.e., after separate action firings) would be considered an extended history of those actor states.

With this capability, a wide range of breakpoint conditions can be designed by the user for testing different aspects of a dataflow program's execution. For example, and without limitation, a user is able to specify any of the following types of breakpoint conditions:
Halt the program when the connection between port X of actor A and port Y of actor B contains more than N tokens (where N≧0)
Halt the program when the value of the output token at port Z of actor C is less than zero
Halt the program when the value, A_X(n), of the input token at port X of actor A, is less than a previous value (i.e., A_{X(n)}<A_{X(n-a)}, where a≧1)
Halt the program when the values [A_{X(n-2)}, Aₓ₍ₙ₋₁₎, A_x(n)] of the input token state history at port X of actor A are [3, 6, 1]
Halt the program when the value of the input token at port X of actor A equals 0 and any consumed input token at port Y of actor B has been negative since the last breakpoint-triggered program halt (or execution start)

The breakpoints can be formulated as Boolean conditions over both the presence and content of current, historic and “in channel” data tokens (i.e., data tokens on a connection). A test for “presence” is a test whether the token(s) exist(s) or not, regardless of its information value. A test for “content” is a test whether the value(s) of the specified token(s) satisfies a specified predicate such as, and without limitation, whether the value(s) is/are less than, equal to, and/or greater than respective values in a specified set of values.

With this approach, execution of a dataflow program can be halted based on overall state conditions of the dataflow graph.

Before presenting in greater detail various aspects relating to implementation of breakpoints in a dataflow program environment, the discussion will first focus on how a user can specify breakpoint conditions. The user's interaction can be entirely textual, or can be graphically based.

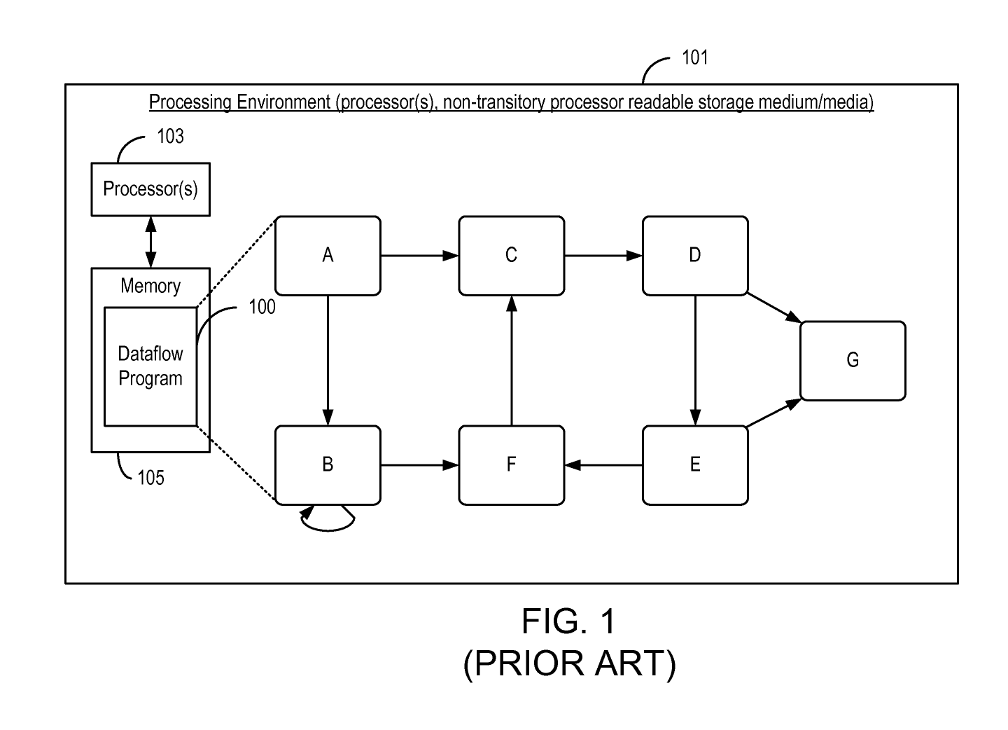

In a graphical embodiment, a view of the dataflow program such as that depicted in FIG. 1 is displayed to the user. Using known Graphical User Interface (GUI) techniques (e.g., displays coupled with input devices such as a mouse, trackball, trackpad, or touchscreen), the user can create a breakpoint by selecting (e.g., by “clicking on”) a connection or port of a target actor. In response to the selection, a tool such as a dataflow program debugging tool displays a breakpoint component similar to an actor. The breakpoint component is populated with the clicked port that minors the port and connection of the target actor, but the breakpoint component also preserves the token history when required. The user can link in further ports, connections, and actor states to the component by connecting them graphically. The breakpoint condition should only read information.

Once the events of interest are specified, the user specifies a breakpoint condition based on the linked events. This specification can be made in a language that is similar to the dataflow description, but is extended to analyze tokens before and after the current token. The result is a Boolean breakpoint decision for each invocation.

When all breakpoints have been specified, program execution is started. In response to a predicate specified by the breakpoint condition being satisfied, potentially all execution of the dataflow program is halted just before the scheduler's execution of the target actor(s) (there can be more than one of them).

During the halted state, the debugger enables the user to inspect tokens, actor states and the like, and then potentially resume execution.

In an exclusively textual environment, the user can describe linked in information based on instance and namespaced resources.

In some alternative embodiments, less general breakpoint condition formulation can be described, for example by clicking on a port and entering a series of values in an input field, which will result in halting the program for the target actor when the pattern of the values is found in the indicated connection and/or current and/or historical tokens.

The focus of this description will now center on various ways of implementing the above-described dataflow program breakpoint capability.

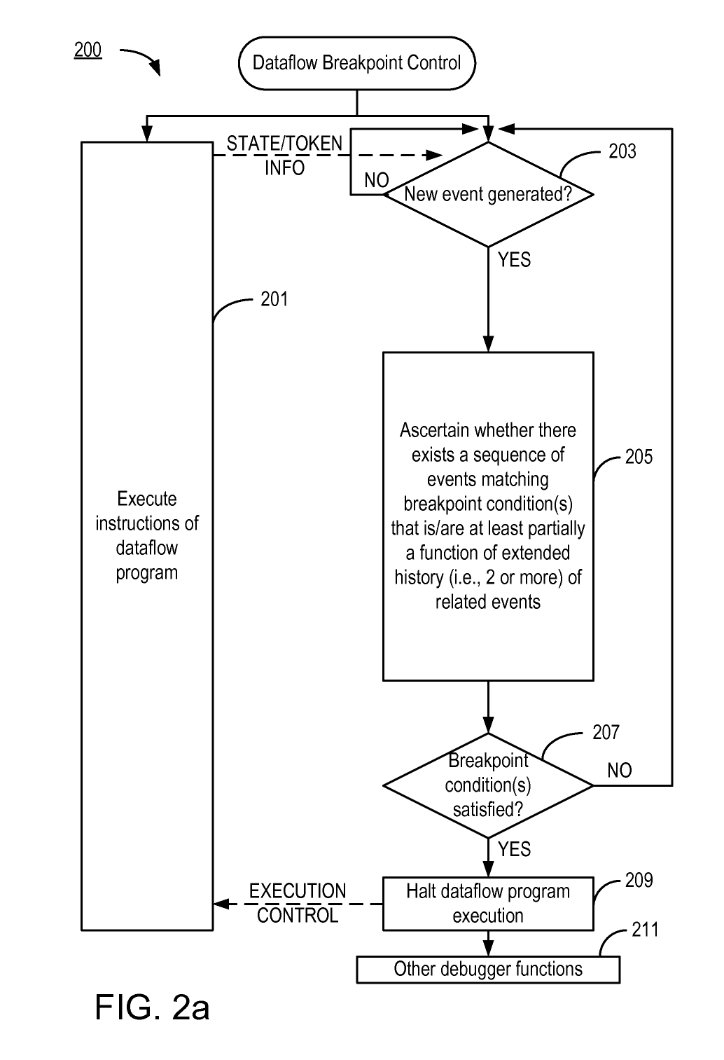

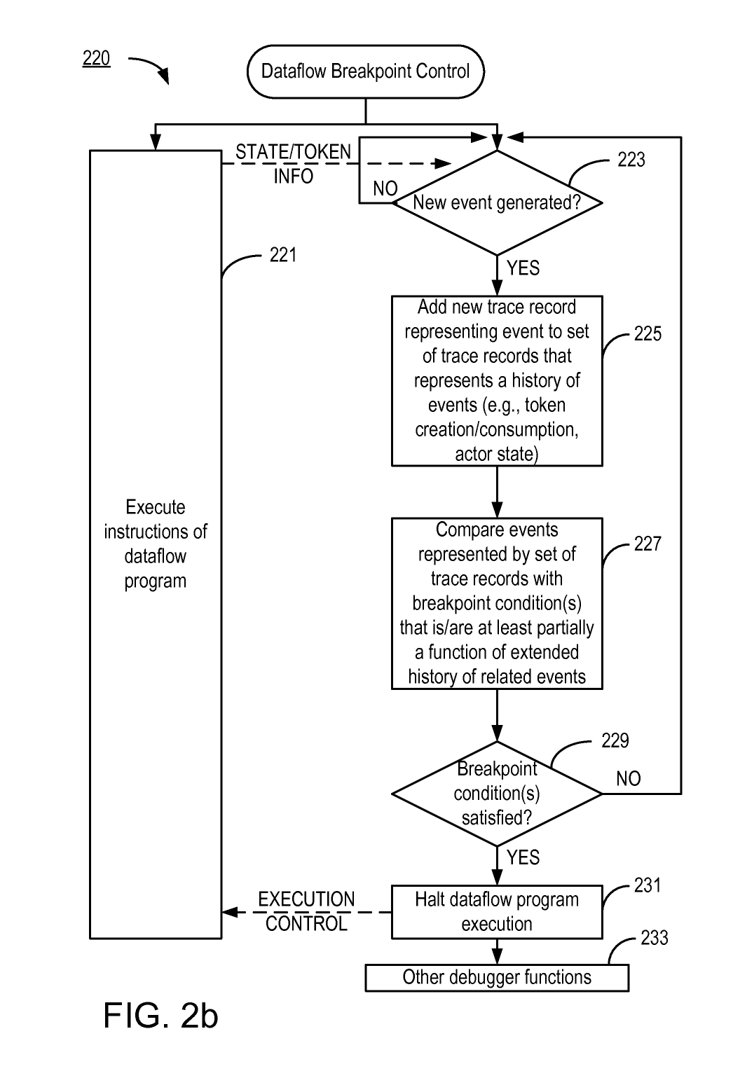

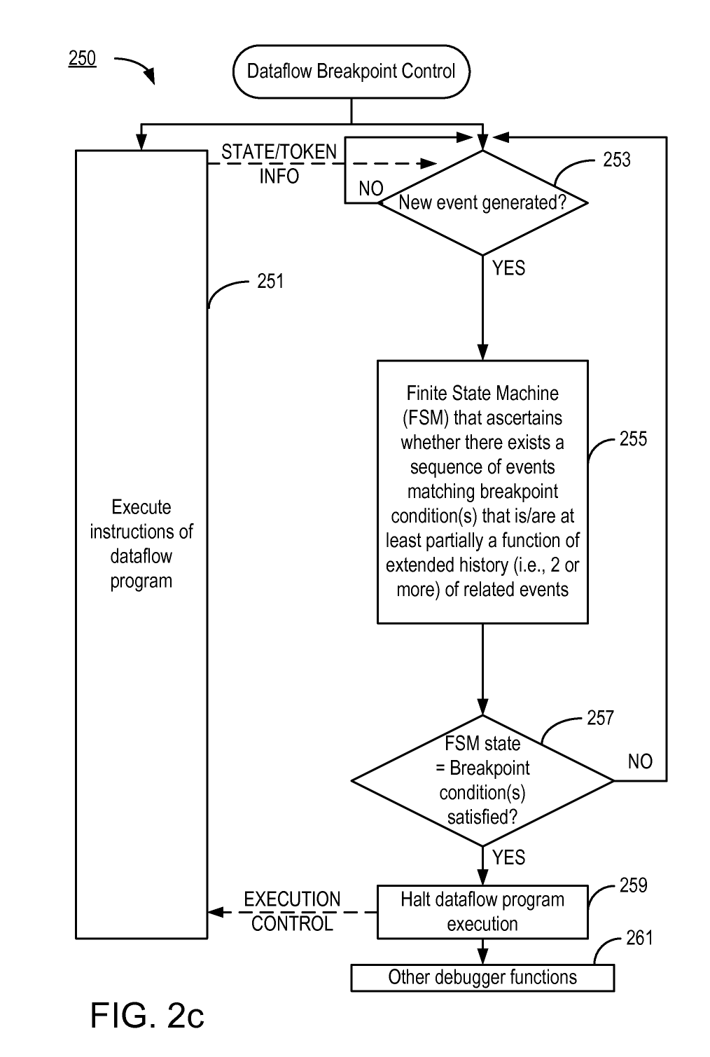

FIG. 2a is, in one respect, a flow chart of steps/processes performed by a debugging tool in accordance with some but not necessarily all exemplary embodiments of the invention. In another respect, FIG. 2a can be considered to depict exemplary means 200 comprising the various illustrated circuitry (e.g., hard-wired and/or suitably programmed processor) configured to perform the described functions.

Dataflow program breakpoint control involves causing one or more processors to access and execute instructions of the dataflow program (step 201). Execution of the instructions of the dataflow program causes a plurality of events to be generated. An event can be, for example, a token produced onto a connection, a token consumed from a connection, or an instance of an actor state after an action firing.

Breakpoint processing is performed substantially concurrently with dataflow program execution. Breakpoint processing is responsive to new events being created (decision block 203). So long as no new events are generated, no breakpoint actions are taken (“NO” path out of decision block 203). However, in response to a new event being generated (“YES” path out of decision block 203), breakpoint control ascertains whether there exists a sequence of events that matches a breakpoint condition (step 205). If a sequence of generated events matches the breakpoint condition (“YES” path out of decision block 207), then execution of the dataflow program is halted (step 209). When dataflow program execution is halted, the user can employ other debugger functions to examine and in some instances modify values of tokens and states in the halted program (step 211). In some instances, the debugger can allow the user to resume execution of the program. The user in some embodiments also has the ability to modify breakpoint conditions before program resumption.

Returning to decision block 207, if the breakpoint condition is not satisfied (“NO” path out of decision block 207), then the breakpoint control resumes monitoring the generation of events by the running program, and repeats processes as described above.

An important aspect of the breakpoint processing is that the breakpoint condition can at least partially be a function of an extended history of related events, wherein two events are considered to be related to one another if they pertain to a same connection or if they pertain to a same actor state, and wherein the extended history comprises at least two related events. Non-limiting examples of such breakpoints were provided earlier in the discussion and therefore need not be repeated.

There are a number of means (and therefore alternative embodiments) by which the above-described breakpoint capability can be provided. One type of embodiment is illustrated in FIG. 2b, which is, in one respect, a flow chart of steps/processes performed by a debugging tool in accordance with some but not necessarily all exemplary embodiments of the invention. In another respect, FIG. 2b can be considered to depict exemplary means 220 comprising the various illustrated circuitry (e.g., hard-wired and/or suitably programmed processor) configured to perform the described functions.

Dataflow program breakpoint control involves causing one or more processors to access and execute instructions of the dataflow program (step 221). Execution of the instructions of the dataflow program causes a plurality of events to be generated. An event can be, for example, a token produced onto a connection, a token consumed from a connection, or an instance of an actor state after an action firing.

Breakpoint processing is performed substantially concurrently with dataflow program execution. Breakpoint processing is responsive to new events being created (decision block 223). So long as no new events are generated, no breakpoint actions are taken (“NO” path out of decision block 223). However, in response to a new event being generated (“YES” path out of decision block 223), a trace record representing the event is created and added to a set of such trace records (step 225). The set therefore represents a history of created events (e.g., a history of tokens that have been created and consumed, as well as a history of actor state instances (i.e., a “snapshot” of an actor state value sampled after an actor's action firing).

The set of trace records is then processed by comparing events represented by the set of trace records with breakpoint conditions (step 227). As before, because tokens and actor states are in a sense preserved in the set of trace records, breakpoint conditions can at least partially be a function of an extended history of related events, wherein two events are considered to be related to one another if they pertain to a same connection or if they pertain to a same actor state, and wherein the extended history comprises at least two related events. For example, the trace records can be examined to pick out those that correspond to a same connection, and in this way determine what the token values were over time on the connection, and/or how many unconsumed tokens existed on the connection at any given moment. A similar analysis can be made with respect to actor state values over time.

If the analysis of trace records concludes that a sequence of events represented by the set of trace records matches the breakpoint condition (“YES” path out of decision block 229), then execution of the dataflow program is halted (step 231). When dataflow program execution is halted, the user can employ other debugger functions to examine and in some instances modify values of tokens and states in the halted program (step 233). In some instances, the debugger can allow the user to resume execution of the program. The user in some embodiments also has the ability to modify breakpoint conditions before program resumption.

Returning to decision block 229, if the breakpoint condition is not satisfied (“NO” path out of decision block 229), then the breakpoint control resumes monitoring the generation of events by the running program, and repeats processes as described above.

In another class of alternative embodiments, the above-described breakpoint capability can be provided by means of a Finite State Machine (FSM) instead of a set of trace records. This is illustrated in FIG. 2c, which is, in one respect, a flow chart of steps/processes performed by a debugging tool in accordance with some but not necessarily all exemplary embodiments of the invention. In another respect, FIG. 2c can be considered to depict exemplary means 250 comprising the various illustrated circuitry (e.g., hard-wired and/or suitably programmed processor) configured to perform the described functions.

Dataflow program breakpoint control involves causing one or more processors to access and execute instructions of the dataflow program (step 251). Execution of the instructions of the dataflow program causes a plurality of events to be generated. An event can be, for example, a token produced onto a connection, a token consumed from a connection, or an instance of an actor state after an action firing.

Breakpoint processing is performed substantially concurrently with dataflow program execution. Breakpoint processing is responsive to new events being created (decision block 253). So long as no new events are generated, no breakpoint actions are taken (“NO” path out of decision block 253). However, in response to a new event being generated (“YES” path out of decision block 253), information representing the actor state or token information (represented in FIG. 2c as the dashed line emanating from block 251) is supplied to a FSM. The FSM is designed such that the new information causes its own state to transition in accordance with the user-designed breakpoint condition(s). The FSM's own state transitioning is a mechanism that ascertains whether there exists a sequence of events matching breakpoint condition(s) that is/are at least partially a function of an extended history of related events (step 255). There is at least one state within the FSM that represents satisfaction of one or more breakpoint conditions. Because the FSM's own states will transition from one to another as a function of the particular sequence of events presented as input, breakpoint conditions can at least partially be a function of an extended history of related events, wherein two events are considered to be related to one another if they pertain to a same connection or if they pertain to a same actor state, and wherein the extended history comprises at least two related events.

If the FSM reaches a state indicating satisfaction of a breakpoint condition (“YES” path out of decision block 257), then execution of the dataflow program is halted (step 259). When dataflow program execution is halted, the user can employ other debugger functions to examine and in some instances modify values of tokens and states in the halted program (step 261). In some instances, the debugger can allow the user to resume execution of the program. The user in some embodiments also has the ability to modify breakpoint conditions before program resumption.

Returning to decision block 257, if the breakpoint condition is not satisfied (“NO” path out of decision block 257), then the breakpoint control resumes monitoring the generation of events by the running program, and repeats processes as described above.

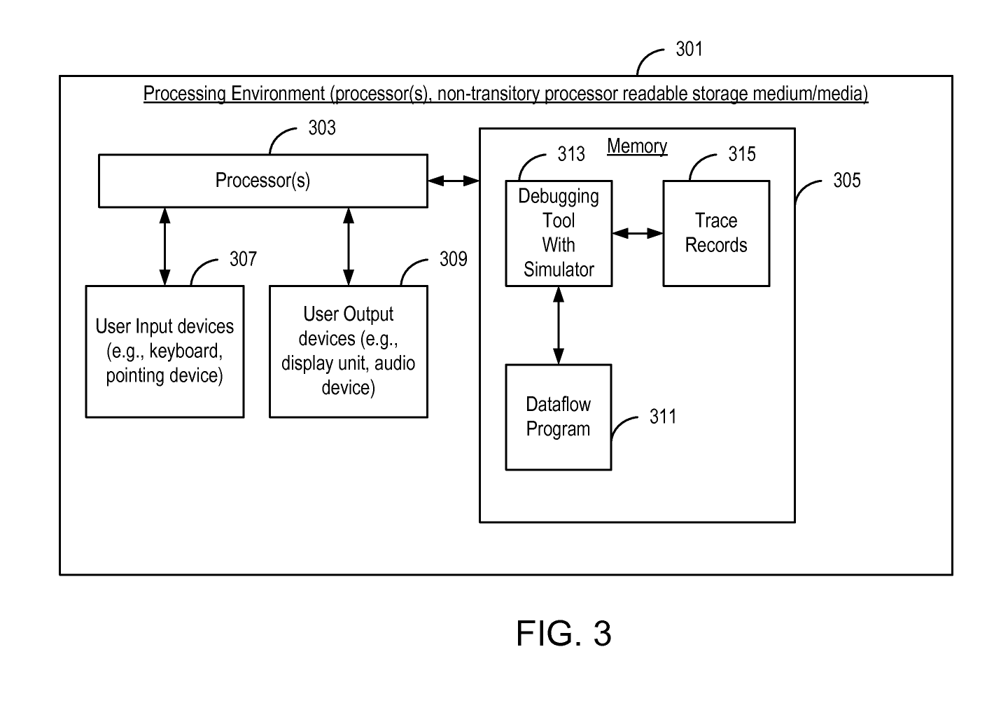

In another aspect of embodiments consistent with the invention, the breakpoint processing can monitor and control execution of the dataflow program in any of a number of ways. FIG. 3 is a block diagram showing a class of exemplary embodiments of a processing environment that includes elements for enabling breakpoint functionality with respect to a dataflow program.

A processing environment 301 is provided that comprises one or more processors 303 coupled to processor-readable media (e.g., one or more electronic, magnetic, or optical memory devices 305—hereinafter generically referred to as “memory 305”). The user is able to interact with and control the processor(s) 303 by means of user input devices 307 (e.g., keyboard, and some sort of pointing device) and user output devices 309 (e.g., display unit, audio device).

The processor(s) 303 are configured to access the memory 305 to retrieve and execute the dataflow program instructions 311 as well as program instructions that constitute a debugging tool associated with a simulator 313. Use of a simulator 313 is advantageous during the early stages of dataflow program development because of the relatively few steps involved in altering the dataflow program and debugging it. In this exemplary embodiment, the simulator 313 creates trace records 315 as described earlier, although it could alternatively perform event analysis by other means such as the FSM approach described above.

In an arrangement such as the one depicted in FIG. 3, the dataflow program 311 is executed in the simulation environment of the debugging tool 313 instead of in the release execution runtime environment. Such simulation executes the dataflow program 311 based on a representation of the dataflow program 311 that is not machine code but is instead at a higher level structure such as a canonical representation of all statements, expressions and definitions in the dataflow program 311. Alternatively, the debugging tool with simulator 313 directly interprets the source code of the dataflow program 311.

In this case the debugger with simulator 313 itself contains methods for recording tokens and actor state, as well as methods that evaluate breakpoint conditions and cause simulation to halt when one or more breakpoint conditions are true (i.e., satisfied). Hence the debugging/breakpoint mechanism is implemented in the simulator. The creation of trace records 315 relating to tokens happens when a token is produced or consumed by the simulator. The creation of trace records 315 relating to actor state happens before or after an actor's action firing by the simulator. The breakpoint condition evaluation is based on the recorded tokens/actor state and happens before or after an action firing. In general terms, the debugging methods are included in the simulator executable in a manner that executes these in accordance with the data flow simulation.

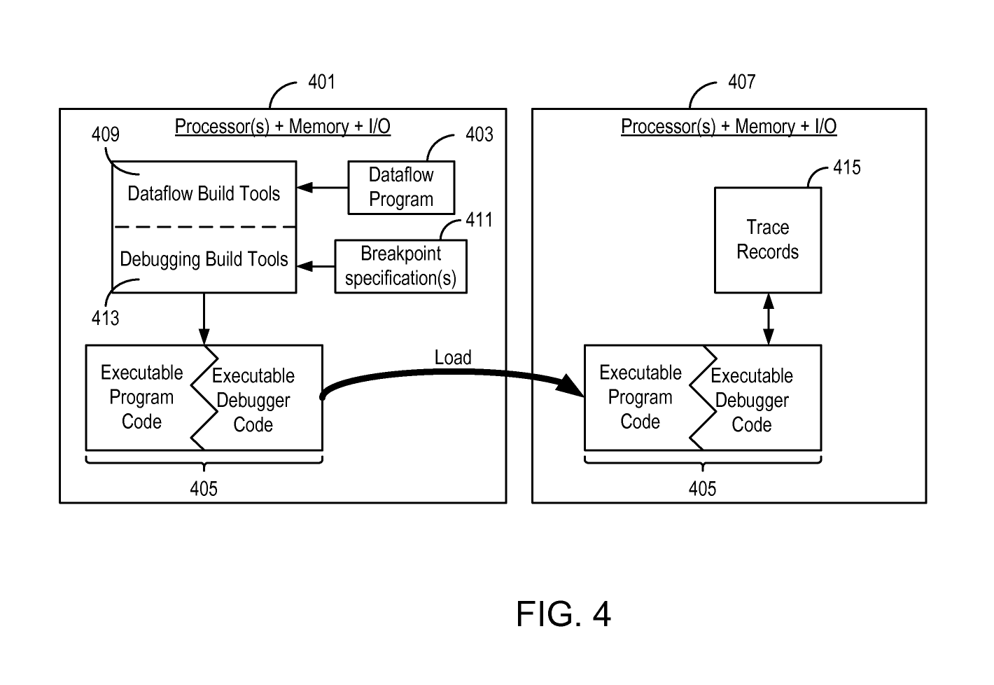

FIG. 4 is a block diagram showing a class of exemplary alternative embodiments of a processing environment that includes elements for enabling breakpoint functionality with respect to a dataflow program. The approach taken in this class of embodiments is to extend the dataflow program's runtime environment by incorporating pattern breakpoint capabilities. Then, during the scheduler's evaluation of what action to execute next, the breakpoint conditions are also evaluated (at least for the conditions with a target actor equal to the scheduled actor). The breakpoint condition evaluation is done by collecting the data relevant for the condition. This includes storing tokens that have been processed (e.g., if a pattern extends to n−3 token positions, where “n” is the current token, the 3 historical tokens are stored). The runtime has access to data structures for the FIFO buffers and data structures storing internal actor states. Hence, the collection can be done by following references (memory pointers) to these data structures. The runtime also has knowledge of the types of the data structures and hence can decode the content (e.g., finding a data element of the current token). Next, the condition evaluation is performed. If simpler conditions are to be evaluated (e.g., a series of token values) a preprogrammed evaluation can be used to compare the token values with the breakpoint pattern values. For generic conditions, the condition code is either compiled or interpreted. If compiled, the code is dynamically added and executed. When the breakpoint condition is evaluated and found to be satisfied, the dataflow program's execution is halted. Otherwise, dataflow program execution continues.

In the general case, two processing environments, each including one or more processors, some sort of memory, and user Input/Output (I/O) devices, are utilized. It is contemplated that embodiments utilizing just one processing environment could also be created. A first processing environment 401 is utilized to analyze the dataflow program 403 and create therefrom executable code 405 that can be loaded into and executed by a second processing environment 407. Creation of the executable code 405 is achieved by supplying a representation of the dataflow program 403 to dataflow build tools 409 (e.g., compiler, assembler, etc.). Also, a representation of the user's breakpoint specifications 411 is supplied to debugging build tools 413. The outputs of the of the dataflow build tools 409 and debugging build tools 413 are, in any of a number of ways, combined to generate the executable code 405. For example, the dataflow build tools 409 can be a standard compiler for compiling the dataflow program 403. The output of the dataflow build tools 409 can then be supplied as input to the debugging build tools 413. The dataflow build tools 409 generates executable debugger code from the breakpoint specification(s) 411, and inserts this code at suitable places within the supplied dataflow code to thereby generate the executable code 405.

It will be seen then, that in this class of embodiments, a dataflow program 403 is a high level description of a method/program. This description is translated into machine code 405 that is executed on a device/computer constituting the second processing environment 407. During the compilation, the debugging build tools 413 in conjunction with the dataflow build tools 409 can do many transformations of the original dataflow description 403. Specifically for a dataflow program, a mechanism for executing the actor's actions when data is available, space is available for output and specific state/guard conditions are fulfilled is incorporated. A program that is compiled for debugging (or generally for release but with dynamic/runtime enablement) can introduce methods for recording tokens and actor states (represented in FIG. 4 as the trace records 415) in operations that produce or consume a token and at the end or beginning of the action execution. The generated executable code 405 has means for evaluating which action to execute next. After such evaluation, a breakpoint condition related to the action can be evaluated and the execution can halt when a condition is found to be satisfied. Alternatively, the breakpoint condition is evaluated at the beginning or end of an action execution. In general terms the debugging methods are inserted in the generated executable in a manner that executes these in accordance with the data flow execution.

This class of embodiments, in which the dataflow program and breakpoint specifications are, in essence, compiled together to form a single executable code entity 405, is advantageous during “on target device/computer” development because it has low overhead and enables high execution speed.

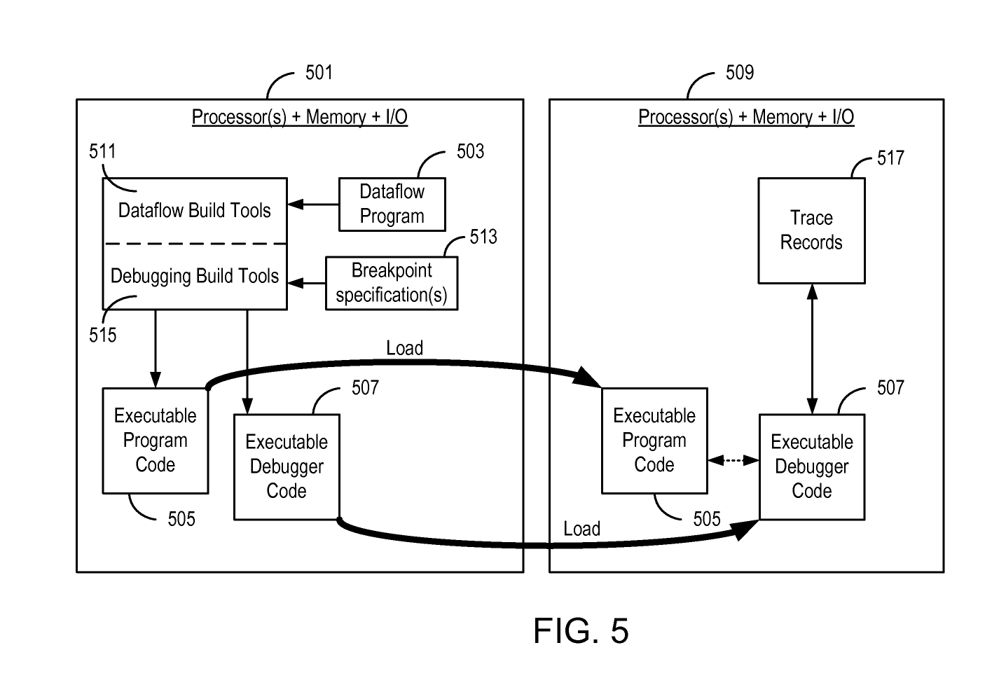

FIG. 5 is a block diagram showing another class of exemplary alternative embodiments of a processing environment that includes elements for enabling breakpoint functionality with respect to a dataflow program. The approach taken in this class of embodiments is to create and then run a set of executable dataflow program instructions in its normal runtime environment. Concurrent with this execution is the execution of debugger code. The events generated by the dataflow program execution are extracted and/or evaluated by the debugger code. If a breakpoint condition is satisfied, then execution of the dataflow program is halted. Otherwise, it is allowed to continue.

In the general case, two processing environments, each including one or more processors, some sort of memory, and user Input/Output (I/O) devices, are utilized. It is contemplated that embodiments utilizing just one processing environment could also be created. A first processing environment 501 is utilized to analyze the dataflow program 503 and create therefrom executable program code 505 and executable debugger code 507 that can each be loaded into and executed by a second processing environment 509. Creation of the executable program code 505 is achieved by supplying a representation of the dataflow program 503 to dataflow build tools 511 (e.g., compiler, assembler, etc.). Similarly, creation of the executable debugger code 507 is achieved by supplying a representation of the user's breakpoint specifications 513 to debugging build tools 515 (e.g., compiler, assembler, etc.). The separate outputs of the of the dataflow build tools 511 and debugging build tools 515 are loaded into the second processing environment 509.

It will be seen then, that in this class of embodiments, a dataflow program 503 is a high level description of a method/program. This description is translated into machine code that is executed by the second processing environment 509 (e.g., a device/computer). Generally, the dataflow program's executable machine code has metadata (symbols) that describes function entry points or data placements. Symbols are commonly a character string and a corresponding reference to memory placement. Memory placement can be absolute, but generally is an offset from a memory address decided at runtime. Sometimes symbols are contained in the executable program; alternatively, these can be stored separately. When debugging the executable program code 505, the executable debugger code 507 hosts the debugged program in the same process context. Hence the executable program code 505 has access to the process memory and the program execution.

The debugger has knowledge of symbols for methods of each action firing, each action selection, and sometimes token read/write events. This knowledge can be based on symbol character strings having a distinct convention in the compiler, e.g. “Actor_<actorname>_Action_<actionname>”, with the “< . . . >” being replaced with actual names of actors and actions. Alternatively the symbols are categorized separately (e.g., all action entries/exits are placed in a separate section (a general section for executable code exists but it is possible to have other sections). The debugger also has knowledge of the data structures containing token FIFO buffers and actor states and their placement in memory because it can monitor the creation of those structures. In one embodiment the compiler generates code for a method that constructs the actor data structure and allocates it in memory. When the debugger has knowledge of the symbol for the actor constructor and then detects that the constructor has allocated the actor state data structure, it can first save the allocated memory address and the size of the allocation. Alternatively, the data structure can be statically allocated and hence can be directly found by its symbol in the metadata.

The debugger can then trap execution of these methods, either entering or leaving. A trap can be realized in several different ways, such as by replacing the first instruction in the method with a jump to debugger specific code, or by configuring the processor to issue an interrupt when execution reaches the memory address of the trapped method; this interrupt then initiates execution of debugger methods. The debugger will then, in the trap and based on what method was trapped, do recording of tokens or recording of state by copying data structures from the program to the debugger allocated memory. This results in creation of the trace records 517. When the trap is of an action execution entry or exit, a related breakpoint condition can be evaluated by methods in the debugger based on the recorded information (or by alternative means, such as the FSM described earlier). When the condition is found to be satisfied (e.g., Boolean expression equals “true”) the dataflow program's execution is halted. In general terms, the debugging methods are included in the executable debugger code 507 and the debugged executable execution is altered at runtime in a manner that executes these in accordance with the data flow execution.

The discussion will now focus on further aspects relating to recording and retrieving token and state information. When creating records pertaining to actor states or tokens, a memory area or buffer is allocated whose size should be large enough to hold the needed amount of tokens/actor state information. The needed amount space can be based on the specified breakpoint condition. For example, if the breakpoint condition requires an Nth most recent token on a connection, then the buffer should be large enough to hold at least N tokens (i.e., large enough to hold the most recent through Nth most recent tokens on the specified connection). The allocated trace record space can be larger in order to accommodate storage of other information, such as but not limited to keeping track that a write happened before the breakpoint condition evaluation. As another example, if it is known that the production or consumption of tokens is made in batches, then the buffer for trace record storage should hold a certain number of batches.

If the buffer not only holds old tokens but also produced but not yet consumed tokens, the buffer should be extended by the length of the buffer of the executable code's actual token buffer. Generally, these buffers are handled as a ring buffer, in which tokens are written at a write position and read at a read position, although this is not an essential aspect of the invention. The read/write positions are wrapped at the end of the buffer to the beginning of the buffer (e.g., by applying a modulus operation on the positions). A read position is not allowed to pass the write position. In the case when produced but not yet consumed tokens are included, then a consumed position within the ring buffer also needs to be updated in accordance with the execution of the program.

Recording of actor state is similar to the recording of tokens. The information that is saved from the actor state might be the whole actor state data structure. However, it is preferable but not essential that any constant values in the data structure not be saved more than once. An advantageous practice is to save the elements in the actor state data structure that is part of the breakpoint condition expression. The size of the elements of the data structure that are used can be multiplied by the largest number of historic values required in the breakpoint condition expression in order to derive the size of the actor state information buffer. This buffer is also preferably handled as a ring buffer, although this is not an essential aspect of the invention.

Alternatives to recording data in ring buffers exist. For breakpoint condition expressions that require long or infinite buffers, it is possible to only sparsely record the actor state and output tokens information, but all input tokens and action firings need to be recorded in order of occurrence/production/consumption. Using the stored information, the actor actions and states can later be recreated by starting from the actor state that was recorded at a point in time before the requested data, and re-executing the program until the missing (i.e., non-recorded) data is re-computed.

Another alternative trace record storage mechanism is the use of a linked list of data elements, each element referring to its next and/or previous data element in order. New elements are inserted in the list and no longer needed elements are removed from the list.

Yet another alternative is to store the trace record data in a database that is indexed with what action in which actor and in which order (e.g., 10,3,234234,<binary data>), where the first two index numbers refer to specific instances of actor and action, the third (large number) is a running counter), and “<binary data>” refers to the token/state value being indexed.

Yet another alternative is to store the data in a graph database, where each entry points to the next following entry, with each entry containing the token or actor state data element. The references between entries replicate data dependencies/order, as well as references to entries constituting actor, action and actor port instances.

When only a relatively short number of sequences is specified in a breakpoint condition, the ring buffer is a preferable implementation of trace record storage. What constitutes “short” in this context changes based on available storage in any given embodiment. For example, in the context of an exemplary embodiment, “short” might mean fewer than 1000. However over time, as technology advances and storage becomes cheaper and more plentiful, a “short” number of sequences might refer to many more than 1000. With a large number of actor state data elements or tokens then either the sparse buffer or database methods are preferred. It is also possible to use all methods simultaneously but for different tokens/data elements.

When recording tokens/data elements, a debugger recording method is executed that uses any of the previous methods to store the data. When evaluating the breakpoint condition expression, the debugger method retrieves the data using offset from the current consumption position. For the simplest ring buffer, the consumption position is implied at the write position.

For recording methods that do not record a token when it is produced but instead make this recording when the token is consumed, a produced but not-yet-consumed token will only be contained in the debugged program's token queue. In this case, retrieval of a token that has not yet been consumed is accomplished by using method of peeking (with an offset) into the debugged program's token queue. Alternatively, the debugger can have its own implementation of such peeking method.

In some embodiments, the debugger keeps a data structure that maps the placement of the data with a logical identification of it. For example, the buffer with the tokens from a certain instance of a port can be placed at a certain memory address.

The discussion will now focus on aspects relating to breakpoint condition expression. The breakpoint expression has data retrieval methods as previously described. These methods can retrieve the data in relation to the consumption position either previous or upcoming in order.

For the simple token pattern condition based on a series of numbers, the breakpoint condition expression is evaluated by retrieving the data from the trace records at the specified offset positions and comparing the retrieved data with the literals/constants in the breakpoint expression. When all comparisons indicate a match, the condition is satisfied (true).

For more elaborate breakpoint conditions, the condition expression can be evaluated by either compiling and executing it or by interpreting it. Such evaluation will form a series of data retrievals and matching operations as described above for the simple case. It is also so that a breakpoint expression might indicate an actor state that is updated and needs to match a condition expression. To consider an example, the breakpoint condition “Stop the program when the value of the input token at port X of actor A equals 0 and any processed input token at port Y of actor B has been negative since last hit of this breakpoint (or execution start).” can be expressed as follows:

```
Breakpoint_state_defintions {
  boolean B_cond=false;
}
Breakpoint_condition_expression {
  if(B.Y[0]<0) then
    B_cond=true;
  end
  if(A.X[1]==0 and B_cond==true) then
    condition = true;
    B_cond=false;
  end
}
```

This is then translated into the following series of retrievals and matches:
Retrieve Port Y on Actor instance B at offset 0
Match retrieved value with expression <0 and when expression is true set breakpoint state B_cond to true and when expression is false do nothing
Retrieve Port X on Actor instance A at offset 1
Match retrieved value with expression==0 and when expression is true (match breakpoint state B_cond with expression true and when expression is true set breakpoint final condition to true and B_cond to false, when expression is false do nothing), when expression is false do nothing
Return breakpoint condition boolean.

Techniques for writing an interpreter or compiler evaluation of conditional expressions are known in the art, and therefore need not be described herein in further detail.

The above-described breakpoint technology provides advantages over conventional program debugging techniques. When considering programs made with either a control flow or a data flow programming paradigm, it is desirable to set breakpoints on data conditions to stop program execution only when a potentially erroneous execution is to be made. The above-described breakpoint technology allows the setting of breakpoints in a dataflow program in a structured way and especially allows the time series of token values to be analyzed. Accordingly, more precise breakpoint conditions can be formulated, compared to conventional technology. Such formulations drastically reduce software development time and reduce malfunctions in software products.

The invention has been described with reference to particular embodiments. However, it will be readily apparent to those skilled in the art that it is possible to embody the invention in specific forms other than those of the embodiment described above. Accordingly, the described embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method of controlling execution of a dataflow program that defines one or more actors and one or more connections, wherein each connection passes a token from an output port of any one of the actors to an input port of any one of the actors, and wherein each of the actors has an actor state, the method comprising:
causing one or more processors to access and execute instructions of the dataflow program, wherein execution of the instructions of the dataflow program causes a plurality of events to be generated, wherein each event is a token produced onto a connection, a token consumed from a connection, or an instance of an actor state after an action firing;
in response to generation of an event, ascertaining whether there exists a sequence of events that matches a breakpoint condition, and if a sequence of events that matches the breakpoint condition exists, then causing execution of the dataflow program to halt,
wherein the breakpoint condition is at least partially a function of an extended history of related events, wherein two events are considered to be related to one another if they pertain to a same connection or if they pertain to a same actor state, and wherein the extended history comprises at least two related events.

2. The method of claim 1, comprising:
for each generated event, adding a trace record to a set of trace records that represents a sequence of generated events, wherein the added trace record represents the generated event,
wherein ascertaining whether there exists a sequence of events that matches a breakpoint condition comprises processing the set of trace records to ascertain whether there exists in the set of trace records a representation of a sequence of events represented by the set of trace records that matches the breakpoint condition.

3. The method of claim 2, wherein adding the trace record to the set of trace records that represents the sequence of events comprises:
causing the one or more processors to execute trace record creating instructions that have been merged into a set of program instructions that were generated by a dataflow program build tool.

4. The method of claim 1, wherein ascertaining whether there exists a sequence of events that matches a breakpoint condition comprises:
causing the one or more processors to execute breakpoint ascertaining instructions that have been merged into a set of program instructions that were generated by a dataflow program build tool.

5. The method of claim 1, wherein ascertaining whether there exists a sequence of events that matches a breakpoint condition comprises:
concurrent with causing the one or more processors to access and execute instructions of the dataflow program, causing the one or more processors to trap execution of dataflow program instructions that create tokens or consume tokens, and as part of trap processing to add a trace record to the set of trace records.

6. The method of claim 1, wherein at least one of the breakpoint conditions is at least partly a function of a predicate that is satisfied when there exists at least a minimum number of unconsumed tokens that are associated with one of the connections, wherein the minimum number of tokens is greater than 1.

7. The method of claim 1, wherein at least one of the breakpoint conditions is at least partly a function of a predicate that is satisfied based on a comparison of a value of a first token produced onto a connection with a value of a second token produced onto the connection, wherein the second token is older than the first token.

8. The method of claim 1, wherein at least one of the breakpoint conditions is at least partly a function of a predicate that is satisfied based on a comparison between a specified sequence of values and a historical sequence of two or more token values produced onto a connection.

9. The method of claim 8, wherein the historical sequence of two or more token values produced onto the connection comprises as many token values as were produced onto the connection since a most recent resumption of dataflow program execution following a halting of the dataflow program.

10. The method of claim 1, wherein causing the one or more processors to access and execute instructions of the dataflow program comprises causing the one or more processors to simulate execution of the dataflow program.

11. The method of claim 1, wherein:
causing the one or more processors to access and execute instructions of the dataflow program comprises causing the one or more processors to access and execute a set of program instructions that have been generated by a dataflow program build tool; and
ascertaining whether there exists a sequence of events that matches a breakpoint condition comprises causing the one or more processors to execute breakpoint ascertaining instructions that have been generated by a dataflow program build tool.

12. An apparatus for controlling execution of a dataflow program that defines one or more actors and one or more connections, wherein each connection passes a token from an output port of any one of the actors to an input port of any one of the actors, and wherein each of the actors has an actor state, the apparatus comprising:
circuitry configured to cause one or more processors to access and execute instructions of the dataflow program, wherein execution of the instructions of the dataflow program causes a plurality of events to be generated, wherein each event is a token produced onto a connection, a token consumed from a connection, or an instance of an actor state after an action firing;
circuitry configured to respond to generation of an event by ascertaining whether there exists a sequence of events that matches a breakpoint condition, and if a sequence of events that matches the breakpoint condition exists, then causing execution of the dataflow program to halt,
wherein the breakpoint condition is at least partially a function of an extended history of related events, wherein two events are considered to be related to one another if they pertain to a same connection or if they pertain to a same actor state, and wherein the extended history comprises at least two related events.

13. The apparatus of claim 12, comprising:
circuitry configured to add, for each generated event, a trace record to a set of trace records that represents a sequence of generated events, wherein the added trace record represents the generated event,
wherein ascertaining whether there exists a sequence of events that matches a breakpoint condition comprises processing the set of trace records to ascertain whether there exists in the set of trace records a representation of a sequence of events represented by the set of trace records that matches the breakpoint condition.

14. The apparatus of claim 13, wherein the circuitry configured to add the trace record to the set of trace records that represents the sequence of events comprises:
circuitry configured to cause the one or more processors to execute trace record creating instructions that have been merged into a set of program instructions that were generated by a dataflow program build tool.

15. The apparatus of claim 12, wherein ascertaining whether there exists a sequence of events that matches a breakpoint condition comprises:
causing the one or more processors to execute breakpoint ascertaining instructions that have been merged into a set of program instructions that were generated by a dataflow program build tool.

16. The apparatus of claim 12, wherein ascertaining whether there exists a sequence of events that matches a breakpoint condition comprises:
concurrent with causing the one or more processors to access and execute instructions of the dataflow program, causing the one or more processors to trap execution of dataflow program instructions that create tokens or consume tokens, and as part of trap processing to add a trace record to the set of trace records.

17. The apparatus of claim 12, wherein at least one of the breakpoint conditions is at least partly a function of a predicate that is satisfied when there exists at least a minimum number of unconsumed tokens that are associated with one of the connections, wherein the minimum number of tokens is greater than 1.

18. The apparatus of claim 12, wherein at least one of the breakpoint conditions is at least partly a function of a predicate that is satisfied based on a comparison of a value of a first token produced onto a connection with a value of a second token produced onto the connection, wherein the second token is older than the first token.

19. The apparatus of claim 12, wherein at least one of the breakpoint conditions is at least partly a function of a predicate that is satisfied based on a comparison between a specified sequence of values and a historical sequence of two or more token values produced onto a connection.

20. The apparatus of claim 19, wherein the historical sequence of two or more token values produced onto the connection comprises as many token values as were produced onto the connection since a most recent resumption of dataflow program execution following a halting of the dataflow program.

21. The apparatus of claim 12, wherein causing the one or more processors to access and execute instructions of the dataflow program comprises causing the one or more processors to simulate execution of the dataflow program.

22. The apparatus of claim 12, wherein:
the circuitry configured to cause the one or more processors to access and execute instructions of the dataflow program comprises circuitry configured to cause the one or more processors to access and execute a set of program instructions that have been generated by a dataflow program build tool; and
ascertaining whether there exists a sequence of events that matches a breakpoint condition comprises causing the one or more processors to execute breakpoint ascertaining instructions that have been generated by a dataflow program build tool.

23. A computer readable storage medium having stored thereon instructions that, when executed by processing equipment, cause the processing equipment to perform a method of controlling execution of a dataflow program that defines one or more actors and one or more connections, wherein each connection passes a token from an output port of any one of the actors to an input port of any one of the actors, and wherein each of the actors has an actor state, the method comprising:
causing one or more processors to access and execute instructions of the dataflow program, wherein execution of the instructions of the dataflow program causes a plurality of events to be generated, wherein each event is a token produced onto a connection, a token consumed from a connection, or an instance of an actor state after an action firing;
in response to generation of an event, ascertaining whether there exists a sequence of events that matches a breakpoint condition, and if a sequence of events that matches the breakpoint condition exists, then causing execution of the dataflow program to halt,
wherein the breakpoint condition is at least partially a function of an extended history of related events, wherein two events are considered to be related to one another if they pertain to a same connection or if they pertain to a same actor state, and wherein the extended history comprises at least two related events.
